(19) United States
(12) Patent Application Publication
(10) Pub. No.: US 2015/0244422 A1
(43) Pub. Date: Aug. 27, 2015

(54) MEMORY DEVICE INCLUDING WIRELESS COMMUNICATION FUNCTION

(71) Applicant: KABUSHIKI KAISHA TOSHIBA, Minato-ku (JP)

(72) Inventors: Shinya OHASHI, Kamakura (JP); Keisuke SATO, Yokohama (JP); Kazuo WATANABE, Kokubunji (JP)

(73) Assignee: KABUSHIKI KAISHA TOSHIBA, Minato-ku (JP)

(21) Appl. No.: 14/475,945

(22) Filed: Sep. 3, 2014

Related U.S. Application Data
(60) Provisional application No. 61/944,942, filed on Feb. 26, 2014.

(51) Int. Cl. H04B 5/00; H04W 48/16

(52) U.S. Cl. CPC H04B 5/0031; H04B 5/0081; H04W 48/16

(57) ABSTRACT

According to one embodiment, a memory device includes a semiconductor memory device, an NFC antenna, and an NFC controller. The semiconductor memory device is capable of wireless communication. The NFC antenna generates power based on electromagnetic induction. The NFC controller is electrically connected to the NFC antenna, stores initial setting data associated with wireless communication, and outputs the initial setting data using the NFC antenna.

### CROSS-REFERENCE TO RELATED APPLICATIONS

This application claims the benefit of U.S. Provisional Application No. 61/944,942, filed Feb. 26, 2014, the entire contents of which are incorporated herein by reference.

### FIELD

Embodiments described herein relate generally to a memory device including a wireless communication function.

### BACKGROUND

A memory card is an example of a semiconductor memory device, and an SD card is an example of the memory card. In recent years, a semiconductor memory device with a wireless communication function is introduced commercially. A wireless communication technique applicable to the semiconductor memory device includes, for example, a wireless local area network (LAN), such as Wi-Fi, and short-range wireless communication, such as Bluetooth.

### BRIEF DESCRIPTION OF THE DRAWING

FIG. 1 is a block diagram showing an example of a configuration of an information processing system according to a first embodiment;

FIG. 2 is a flowchart showing an example of processing for storing initial setting data for a setting device, executed by an information processing device;

FIG. 3 is a flowchart showing an example of processing of the information processing system according to the first embodiment;

FIG. 4 is a drawing shows a specific application example of a memory device according to the first embodiment;

FIG. 5 is a block diagram showing an example of a plurality of initial setting data items stored in a setting device according to a second embodiment;

FIG. 6 is a block diagram showing an example of a configuration of an information processing system according to a third embodiment;

FIG. 7 is a sequence diagram showing an example of processing executed by an initial setting program according to the third embodiment;

FIG. 8 is a flowchart showing an example of transmission/reception of encrypted data using wireless LAN communication in the third embodiment;

FIG. 9 is a data structure diagram showing an example of initial setting data according to a fourth embodiment; and

FIG. 10 is a flowchart showing an example of a data access from an information processing device to a semiconductor memory device according to the fourth embodiment.

### DETAILED DESCRIPTION

Embodiments will be described hereinafter with reference to drawings. In a following description, the same reference numerals denote components having nearly the same functions and arrangements, and a repetitive description thereof will be given if necessary.

In general, according to one embodiment, a memory device includes a semiconductor memory device, a near field communication (NFC) antenna, and an NFC controller. The semiconductor memory device is capable of wireless communication. The NFC antenna generates power based on electromagnetic induction. The NFC controller is electrically connected to the NFC antenna, stores initial setting data associated with wireless communication, and outputs the initial setting data using the NFC antenna.

### First Embodiment

In a first embodiment, a description will be given of a memory device including a semiconductor memory device including a wireless communication function and a setting device corresponding to the semiconductor memory device. A configuration similar to that of the semiconductor memory device of the first embodiment may be applied to a wireless communication device, such as a mobile phone, and an information processing device including a wireless communication function, such as a tablet terminal.

Semiconductor memory devices include various forms of devices, such as a memory card (e.g., an SD memory card or a multimedia card) and a USB memory. In the first embodiment, a description will be given of an example where the semiconductor memory device is a memory card.

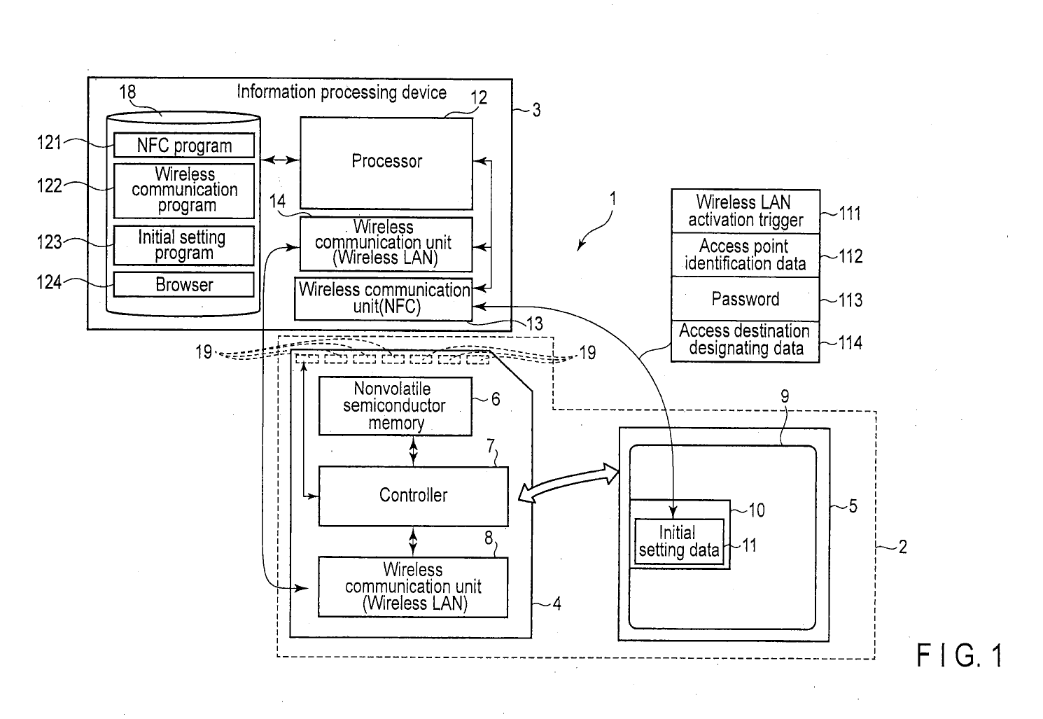

FIG. 1 is a block diagram showing a configuration of an information processing system according to the first embodiment.

An information processing system 1 includes a memory device 2 and an information processing device 3. The memory device 2 includes a semiconductor memory device 4 and a setting device 5 corresponding to the semiconductor memory device 4. The semiconductor memory device 4 and the setting device 5 may be formed integral with each other, or be separate from each other. When the semiconductor memory device 4 and the setting device 5 are formed integral, the setting device 5 may be included in a case of the semiconductor memory device 4.

In the first embodiment, wireless LAN communication is used as wireless communication between the information processing device 3 and the semiconductor memory device 4. However, another wireless communication, such as Bluetooth, may be employed. The information processing device 3 is a station or client device, while the semiconductor memory device 3 is an access point or server device.

Near field communication (NFC) is used as wireless communication between the information processing device 3 and the setting device 5. However, another short-range wireless communication may be employed.

The semiconductor memory device 4 includes a nonvolatile semiconductor memory 6, a controller 7, a wireless communication unit 8 and an interface terminal 19.

Although a NAND type flash memory, for example, is used as the nonvolatile semiconductor memory 6, another nonvolatile semiconductor memory, such as a NOR type flash memory, a magnetoresistive random access memory (MRAM), a phase change random access memory (PRAM), a resistive random access memory (ReRAM) or a ferromagnetic random access memory (FeRAM), may be used.

The controller 7 executes various types of control in the semiconductor memory device 5.

For instance, the controller 7 controls wireless LAN communication by the wireless communication unit 8. Further, the controller 7 executes authentication processing in wireless LAN communication based on a password.

For instance, the controller 7 receives data from the information processing device 3 via the wireless communication unit 8, and stores the data in the nonvolatile semiconductor memory 6. Further, the controller 7 reads data from the nonvolatile semiconductor memory 6 and sends the data to the information processing device 3 via the wireless communication unit 8.

Furthermore, when the semiconductor memory device 4 is mounted to an external device (such as a digital camera), the controller 7 receives data from the external device via the interface terminal 19, and stores the received data in the nonvolatile semiconductor memory 6. Further, when the semiconductor memory device 4 is mounted to the external device, the controller 7 reads data from the nonvolatile semiconductor memory 6, and sends the data to the external device via the interface terminal 19.

Under the control of the controller 7, the wireless communication unit 8 performs a transmission and reception of data to and from the information processing device 3 using wireless LAN communication.

The setting device 5 may be a label of the semiconductor memory device 4, or a seal attached to the inside of the case of the semiconductor memory device 4. The setting device 5 includes an antenna 9 and a controller 10. The setting device 5 can be operated by power generated by the antenna 9 even if no power is externally supplied. In the first embodiment, the setting device 5 is realized as an NFC tag storing data that can arbitrarily change setting of the information processing device 3 as a wireless communication host device, such as a smartphone, an integrated circuit (IC) tag, or a radio frequency identification (RFID) tag conforming to the IC tag.

The antenna 9 may include a loop pattern. In the present embodiment, it may be defined that the loop pattern generates electric power by a change of a magnetic flux density in an inside diameter space. For example, the loop pattern may be an annular pattern, a spiral pattern, a coiled pattern, or a scroll pattern. The antenna 9 may be, for example, an NFC antenna. The antenna 9 generates power using electromagnetic induction that occurs upon receiving a radio wave.

The controller 10 is, for example, an NFC chip, and is arranged within the inside diameter space of the loop pattern.

More specifically, the controller 10 is electrically connected to the antenna 9, and is operable by power generated by the antenna 9. The controller 10 stores initial setting data 11 for the wireless LAN communication function. Using the antenna 9, the controller 10 sends the initial setting data 11 to the information processing device 3 that performs initial setting.

The initial setting data 11 includes a wireless LAN activation trigger (activation trigger) 111, access point identification data 112, such as service set identifier (SSID), a password 113, access destination designating data 114, such as uniform resource locator (URL). As will be described later, the initial setting data 11 may also include activation program identification data indicating a program to be activated, a public key, a password for protecting transmission data, access right data, etc.

The information processing device 3 performs initial setting for wireless LAN communication based on the initial setting data 11. The information processing device 3 is, for example, a mobile phone, a smartphone, a computer, a tablet terminal, a printer, etc.

The information processing device 3 includes a memory unit 18, a processor 12, an NFC wireless communication unit 13 and a wireless LAN communication unit 14.

The memory unit 18 stores, for example, an NFC program 121, a wireless communication program 122, an initial setting program 123 and a browser 124.

The processor 12 executes programs stored in the memory unit 18.

For instance, the processor 12 controls the wireless communication unit 13 in accordance with the NFC program 121, and transmits and receives data using NFC. The processor 12 controls the wireless communication unit 14 in accordance with the wireless communication program 122, and transmits and receives data using wireless LAN communication.

After activating, the initial setting program 123 executed by the processor 12 generates the initial setting data 11 based on a user operation, and transmits the generated initial setting data 11 to the setting device 5 via the wireless communication unit 13 using NFC. Further, the initial setting program 123 starts polling of NFC, using the wireless communication unit 13.

When the setting device 5 approaches the information processing device 3, the initial setting program 123 receives the initial setting data 11 from the setting device 5 via the wireless communication unit 13. Then, the initial setting program 123 executes the initial setting for wireless LAN communication between the wireless communication unit 14 and the semiconductor memory device 4 to activate the browser 124.

The browser 124 executed by the processor 12 accesses the data designated by the access destination designating data included in the initial setting data 11.

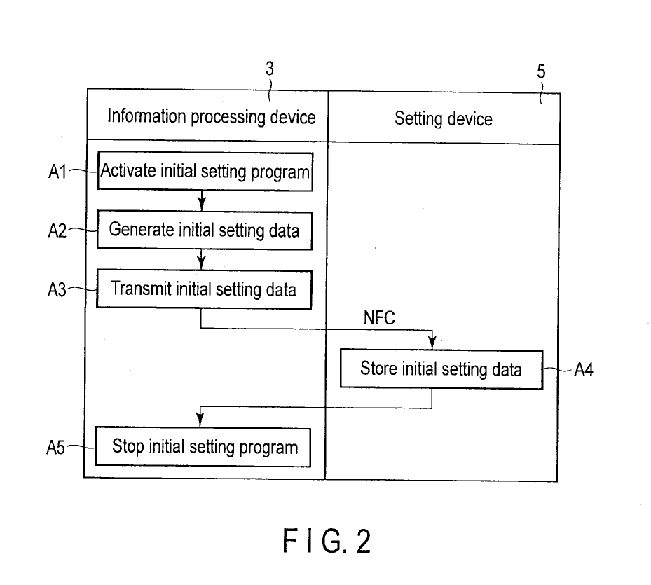

FIG. 2 is a flowchart showing processing, performed by the information processing device 3, of storing the initial setting data 11 in the setting device 5.

In step A1, the initial setting program 123 is activated.

In step A2, a user inputs initial setting, and the initial setting program 123 generates the initial setting data 11 based on a content input by the user.

In step A3, the initial setting program 123 transmits, using NFC, the initial setting data 11 to the setting device 5 via the wireless communication unit 13 controlled by the NFC program 121.

In step A4, the setting device 5 receives the initial setting data 11 by NFC, and stores the initial setting data 11 in the controller 10.

In step A5, the information processing device 3 stops the initial setting program 123.

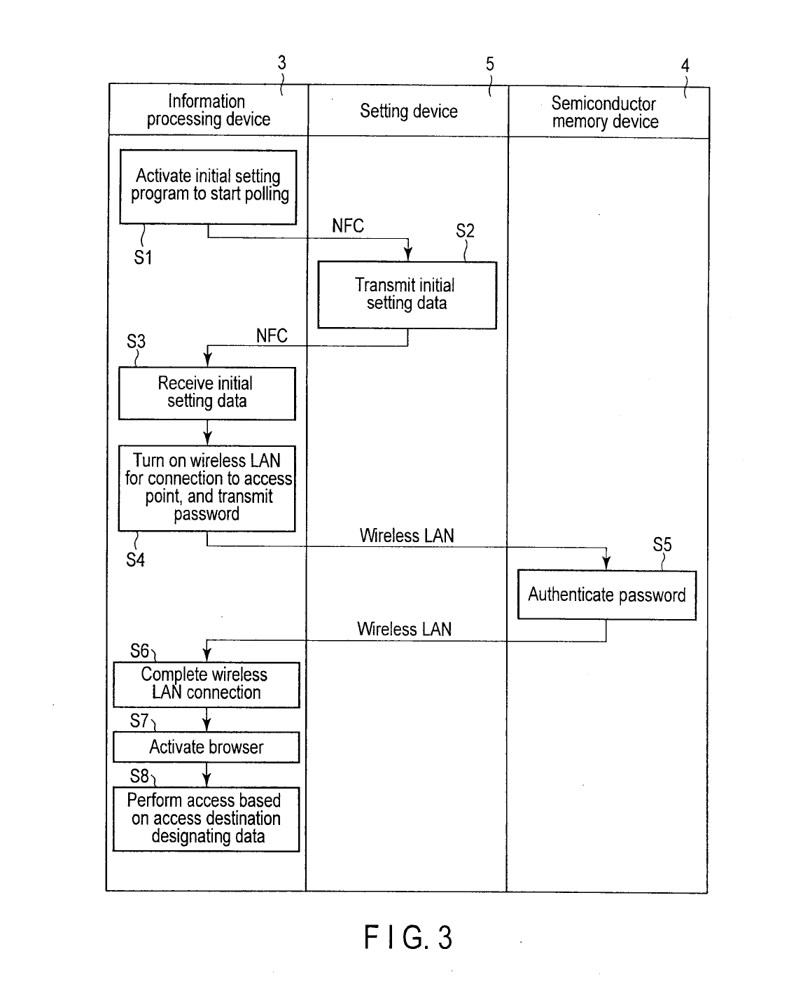

FIG. 3 is a flowchart showing processing of the information processing system 1.

In step S1, the initial setting program 123 of the information processing device 3 is activated. The initial setting program 123 starts polling of NFC via the wireless communication unit 13 controlled by the NFC program 121.

In step S2, when the setting device 5 approaches the information processing device 3, the controller 10 of the setting device 5 transmits the initial setting data 11 to the information processing device 3 through NFC.

In step S3, the initial setting program 123 receives, through NFC, the initial setting data 11 via the wireless communication unit 13 controlled by the NFC program 121.

In step S4, the initial setting program 123 turns on wireless LAN communication in response to the wireless LAN activation trigger 111, executes connection to the access point based on the access point identification data 112 via the wireless communication unit 14 controlled by the wireless communication program 122, and transmits the password 113 to the semiconductor memory device 4 via the wireless communication unit 14 controlled by the wireless communication program 122.

In step S5, the wireless communication unit 8 of the semiconductor memory device 4 receives the password 113, and the controller 7 performs authentication based on the password 113. The controller 7 requests the wireless communication unit 8 to transmit an authentication result. The wireless communication unit 8 transmits the authentication result to the information processing device 3 by wireless LAN communication.

In step S6, the initial setting program 123 of the information processing device 3 receives, using wireless LAN communication, the authentication result via the wireless communication unit 14 controlled by the wireless communication program 122. The initial setting program 123 completes wireless LAN communication connection processing if the authentication result is legitimate.

In step S7, the initial setting program 123 activates the browser 124.

In step S8, the initial setting program 123 supplies the browser 124 with the access destination designating data 114 of the initial setting data 11. The browser 124 accesses data designated by the access destination designating data 114.

In the embodiment, when NFC is used, the memory device 2 does not have to receive power from another device. However, when wireless LAN communication is used, the memory device 2 has to receive power from an external device via the interface terminal 19.

As described above, in the embodiment, initial setting of wireless LAN communication by the information processing device 3 can be realized simply by making the information processing device 3 and the setting device 5 approach each other.

Advantages of the first embodiment will be described in detail.

In the prior art, when initial setting of wireless LAN communication between a smartphone and a memory card is performed by the smartphone, a user needs to perform the following operations (t1) to (t5). These conventional operations may be troublesome and be difficult to understand and execute.

(t1) The memory card including a wireless communication function is inserted into a digital camera, and the camera is turned on.

(t2) The wireless LAN communication function of the smartphone is turned on.

(t3) SSID is selected.

(t4) A password is input.

(t5) The browser of the smartphone is activated, URL is input, and an update button is pressed.

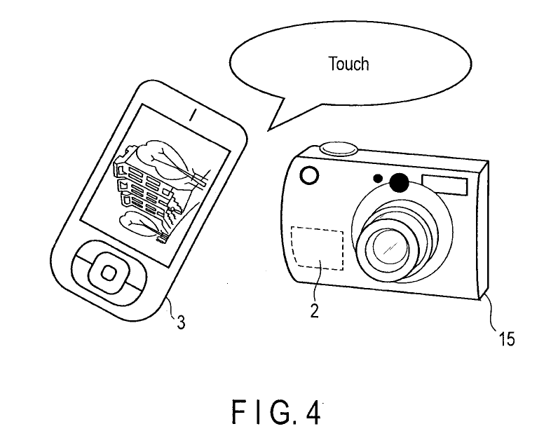

In contrast, FIG. 4 shows a specific application example of the memory device 2 according to the first embodiment. In the first embodiment, simply by performing the following operations (u1) to (u3), the smartphone as the information processing device 3 can realize initial setting of wireless LAN communication.

(u1) The semiconductor memory device 4 is inserted into a digital camera 15, and the camera 15 is turned on

(u2) The initial setting program 123 of the information processing device 3 is activated.

(u3) The setting device 5 is made to approach the information processing device 3.

Thus, the first embodiment can significantly simplify an initial setting operation for wireless LAN communication.

In the first embodiment, once the initial setting data 11 is stored in the setting device 5, it is not necessary to manually input the initial setting data 11 later on through the information processing device 3, which simplifies the initial setting operation.

Further, in the first embodiment, the initial setting data 11 previously input by a user operation is stored in the setting device 5. Accordingly, even if a user does not know the initial setting data 11, wireless LAN connection between the information processing device 3 and the semiconductor memory device 4 can be achieved simply by making the setting device 5 approach the information processing device 3. Thus, the data stored in the semiconductor memory device 4 can be easily shared between a plurality of users. Further, NFC is narrower in communication range than the other wireless communication methods, and hence it is necessary for establishing communication to make the information processing device 4 and the setting device 5 close to each other in a measure. This prevents data in the nonvolatile semiconductor memory 6 from being known by third parties.

### Second Embodiment

A description will now be given of a second embodiment in which the first embodiment is modified in a certain way. In the second embodiment, one setting device 5 enables a plurality of information processing devices to individually perform initial setting of wireless LAN communications.

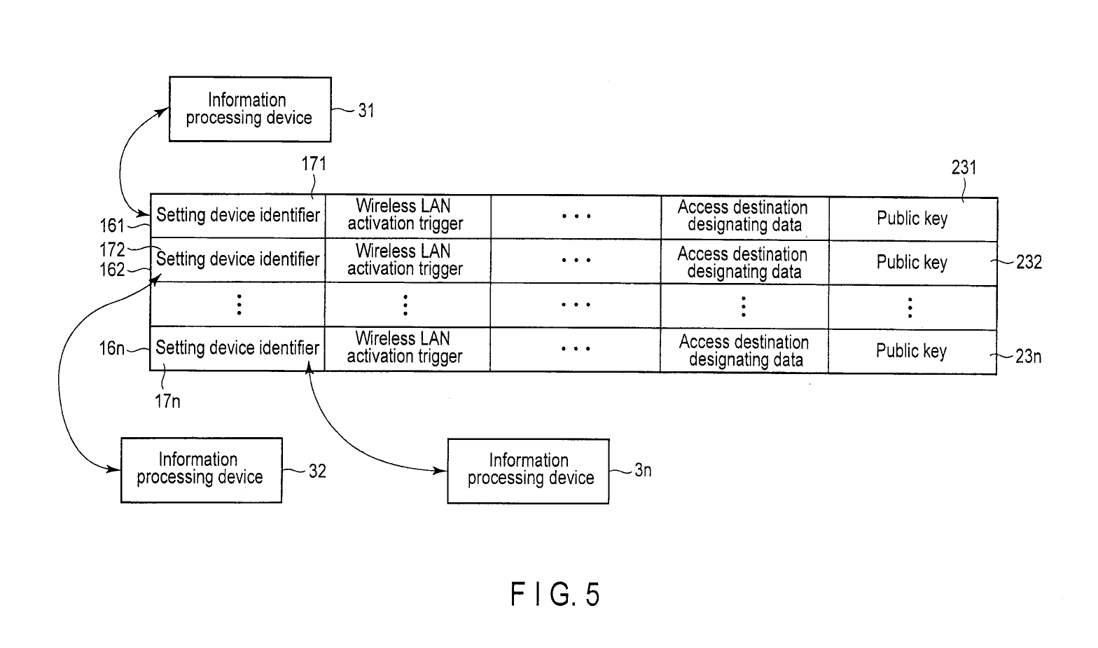

FIG. 5 is a block diagram showing an example of a plurality of initial setting data items stored in a setting device 5 of the second embodiment.

Initial setting data items 161 to 16n each include the wireless LAN activation trigger 111, access point identification data 112 and the password 113, like the initial setting data 11 of the first embodiment.

The initial setting data items 161 to 16n further include setting device identifiers 171 to 17n and public keys 231 to 23n, respectively.

The initial setting data items 161 to 16n are made to correspond to information processing devices 31 to 3n by the setting device identifiers 171 to 17n, respectively.

The initial setting programs 123 of the information processing devices 31 to 3n obtain, using NFCs, the initial setting data items 161 to 16n corresponding to the information processing devices 31 to 3n, based on the setting device identifiers 171 to 17n, respectively, and execute initial setting based on the obtained initial setting data items 161 to 16n, respectively.

As a result, the single setting device 5 enables the plurality of information processing devices 31 to 3n to individually perform the initial setting of wireless LAN communications in an easy manner.

The public keys 231 to 23n are used for encryptions in the information processing devices 31 to 3n, respectively. When performing data transmissions through, for example, wireless LAN communications, the information processing devices 31 to 3n encrypt transmission data using the public keys 231 to 23n, respectively.

By virtue of the above, securities of the data transmissions by the information processing devices 31 to 3n can be maintained.

### Third Embodiment

A description will be given of a third embodiment in which the first and second embodiments are modified in a certain way. In the third embodiment, the initial setting data 11 includes activation program identification data for designating an activation program (e.g., an application) to be automatically activated. The initial setting data 11 also includes key data for encrypting data transmitted from the information processing device 3 to the semiconductor memory device 4.

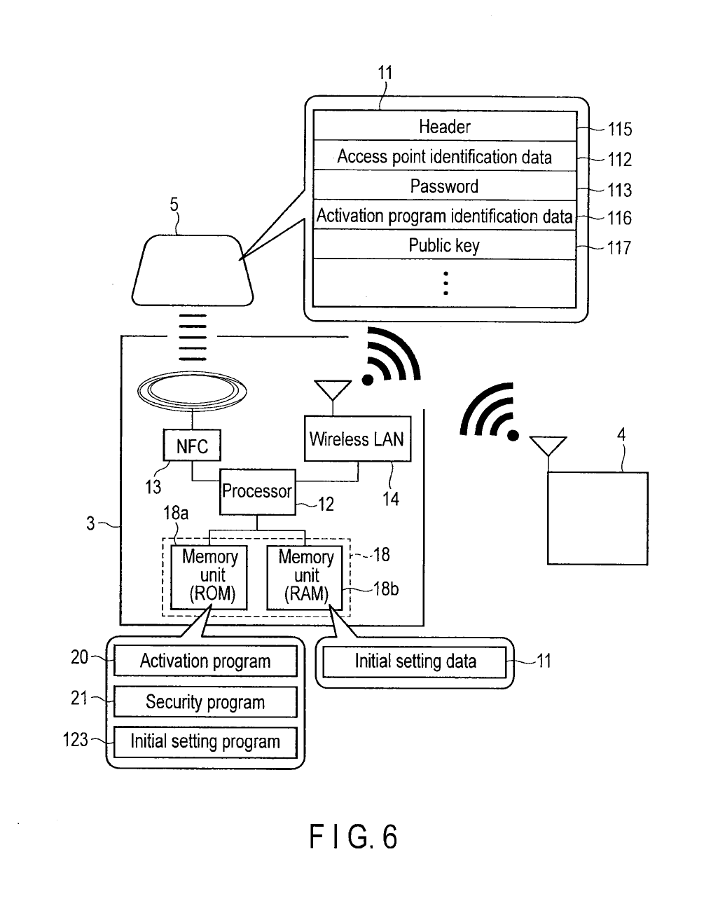

FIG. 6 is a block diagram showing a configuration example of an information processing system 1 according to the third embodiment.

In the third embodiment, the initial setting data 11 includes a header 115, the access point identification data 112, the password 113, activation program identification data 116 and a public key 117.

The access point identification data 112 and the password 113 are used for wireless LAN connection.

The activation program identification data 116 is used for specifying an activation program 20 to be activated.

The header 115 includes, for example, type data indicating that the data is the initial setting data 11, data indicating the data length of the initial setting data 11, the above-mentioned wireless LAN activation trigger 111, setting device identifier 161, etc.

The memory unit 18 of the information processing device 3 includes a memory unit 18a as a read only memory (ROM), and a memory unit 18b as a random access memory (RAM).

The memory unit 18a stores an activation program 20 and a security program 21, in addition to the above-mentioned programs 121 to 124. The activation program 20 is a program to be activated after a completion of a wireless automatic LAN connection, and is used for, for example, receiving a service from the semiconductor memory device 4.

The initial setting program 123 executed by the processor 12 stores, in the memory unit 18b, the initial setting data 11 received, using NFC, from the setting device 5 via the wireless communication unit 13 controlled by the NFC program 121.

The initial setting program 123 analyzes the header 115, and recognizes wireless LAN connection associated data including the access point identification data 112 and the password 113, the activation program identification data 116 and the public key 117, which follow the header 115.

The initial setting program 123 establishes the wireless LAN connection based on the access point identification data 112 and the password 113, via the wireless communication unit 14 controlled by the wireless communication program 122.

After establishing the wireless LAN connector, the initial setting program 123 activates the activation program 20 designated by the activation program identification data 116 stored in the memory unit 18b.

In the third embodiment, a user selects an application (this application is associated with the semiconductor memory device 4) as the activation program 20 from the applications associated with wireless LAN and stored in the information processing device 3, such as a mobile phone. Then, the information processing device 3 transmits, to the setting device 5 using NFC, the initial setting data 11 that includes the activation program identification data 116 indicating the application selected by the user. The setting device 5 receives, using NFC, the initial setting data 11 that includes the activation program identification data 116, and stores the initial setting data 11.

Subsequently, the user makes the setting device 5 approach the information processing device 3. Then, the information processing device 3 receives, from the setting device 5 using NFC, the initial setting data 11 that includes the activation program identification data 116. Based on the initial setting data 11, the information processing device 3 establishes the wireless LAN connection to the semiconductor memory device 4, and automatically launches the application previously selected by the user, based on the activation program identification data 116. The activation program 20 is, for example, the browser 124, mail software, file management software, an image viewer, etc.

In the third embodiment, when the information processing device 3 transmits data to the semiconductor memory device 4 via the wireless communication unit 14 controlled by the wireless communication program 122, using wireless LAN communication after the establishment of the wireless LAN connection, the security program 21 encrypts transmission data using the public key 117, and transmits an encrypted data.

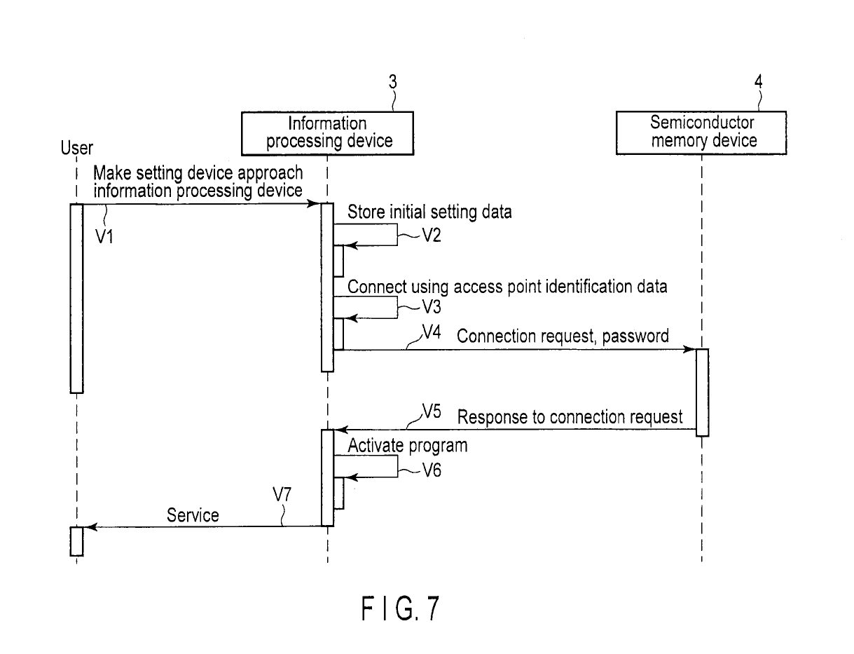

FIG. 7 shows a sequence diagram showing an example of processing executed by the initial setting program 123.

Firstly, in step V1, the user makes the setting device 5 approach the information processing device 3.

In step V2, the initial setting program 123 of the information processing device 3 receives the initial setting data 11 through NFC, and stores the initial setting data 11 in the memory unit 18b.

In step V3, the initial setting program 123 executes wireless LAN connection using the access point identification data 112.

In step V4, the initial setting program 123 transmits a connection request and a password to the semiconductor memory device 4.

In step V5, the initial setting program 123 receives a response to the connection request from the semiconductor memory device 4.

In step V6, if the response to the connection request is legitimate, the initial setting program 123 activates the activation program 20 designated by the activation program identification data 116.

In step V7, the user receives the service provided by the activation program 20.

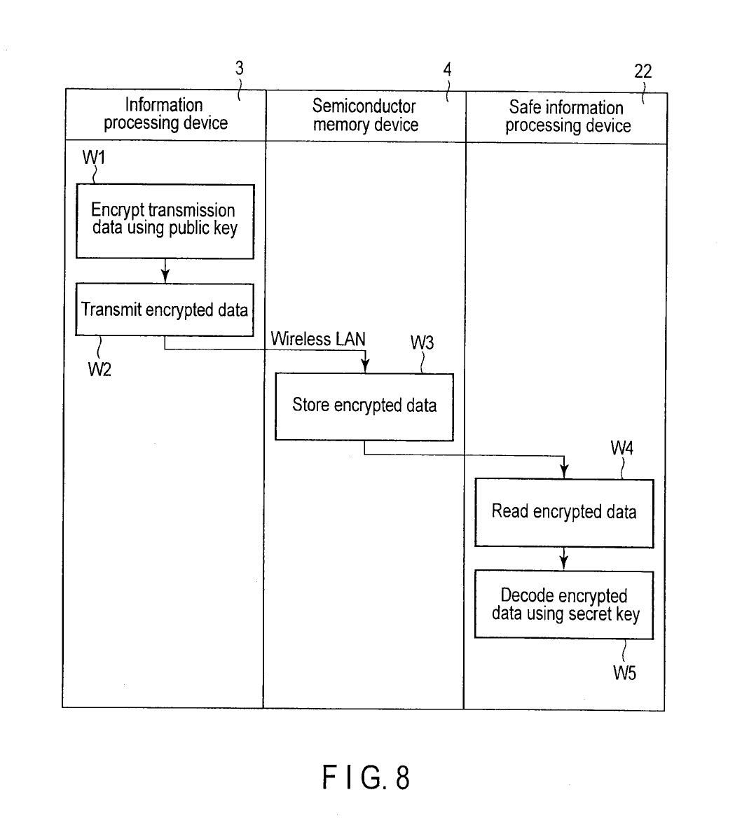

FIG. 8 is a flowchart showing an example of transmission/reception of encrypted data using wireless LAN communication in the third embodiment.

In step W1, if the initial setting data 11 includes the public key 117, the security program 21 of the information processing device 3 encrypts the transmission data using the public key 117 to generate the encrypted data.

In step W2, the wireless communication program 122 and the wireless communication unit 14 transmit the encrypted data to the semiconductor memory device 4 using a wireless LAN.

In step W3, the wireless communication unit 8 of the semiconductor memory device 4 receives the encrypted data, and the controller 7 stores the encrypted data in the nonvolatile semiconductor memory 6.

In step W4, an information processing device 22, which is secure because it is not accessed via the wireless LAN, reads the encrypted data from the semiconductor memory device 4.

In step W5, the secure information processing device 22 decodes the encrypted data using a secret key. Alternatively, the semiconductor memory device 4 may automatically perform the decoding.

In the above-described third embodiment, the activation program 20 can be automatically activated in the information processing device 3, in addition to automatic establishment of the wireless LAN connection between the information processing device 3 and the semiconductor memory device 4. The advantage will be detailed in more detail. In the prior art, when a program for causing an information processing device to receive a service from the semiconductor memory device 4 is activated, it is necessary to firstly manually perform setting of wireless LAN communication, and to manually activate the program after a wireless LAN connection is completed. In contrast, in the third embodiment, setting of wireless LAN communication can be automatically performed simply by making the setting device 5 approach the information processing device 3, and the activation program 20 of the information processing device 3 used to receive a service from the semiconductor memory device 4 can be automatically activated.

In addition, in the third embodiment, even when an unspecified number of users are accessible to the semiconductor memory device 4 via the wireless LAN, they cannot decode the encrypted data stored in the semiconductor memory device 4. The user(s) who has a right of decoding the encrypted data in the semiconductor memory device 4 can decode the encrypted data using the secret key in an environment protected from being accessed via the wireless LAN.

Further, in the third embodiment, even if the encrypted data is intercepted during its transmission through wireless LAN communication, its security is maintained.

For instance, in a college course, a teacher distributes, using the setting device 5, a public key to the information processing device 3 of each student participated in the course. After that, the information processing device 3 of each student having obtained the public key transmits, to the teacher's semiconductor memory device 4, a report encrypted using the public key. Each student cannot see the encrypted report of another student. The secure information processing device 22 operated by the teacher decodes the encrypted report using a secret key in an environment in which the information processing device 3 of each student can not access to the semiconductor memory device 4. Thus, the teacher can receive encrypted reports only from the students who have taken part in the course and have received the public key, and can read them.

When the teacher returns the examination results of the reports to the students, the information processing devices 3 of the students have already received the public key from the teacher's setting device 5. The secure information processing device 22 operated by the teacher encrypts the report examination result of each student, and stores an encrypted report examination result in the semiconductor memory device 4. The information processing device 3 of each student reads their own encrypted report examination result from the semiconductor memory device 4. In this case, it is necessary to prevent the encrypted report examination result of each student from being read by the information processing devices of the other students. To this end, the controller 7 of the semiconductor memory device 4 includes a function of authenticating each student, and permitting each student to read only the corresponding encrypted report examination result. For instance, it is assumed that the controller 7 of the semiconductor memory device 4 includes a login function based on a student ID number and a password. After logging, the information processing device 3 of each student reads only their own encrypted report examination result from the semiconductor memory device 4.

The secure information processing device 22 operated by the teacher may compress the report examination result of each student using their password, encrypt the compressed report examination result using a secret key, and store the compressed and encrypted report examination result in the semiconductor memory device 4. The information processing device 3 of each student receives the corresponding compressed and encrypted report examination result from the semiconductor memory device 4, decodes the compressed and encrypted report examination result using the already obtained public key, and decompresses the decoding result using the corresponding password.

Alternatively, it is assumed that the semiconductor memory device 4 stores data encrypted using a secret key, and that the information processing devices 31 to 3n includes a shared public key. In this case, the information processing devices 31 to 3n decode the encrypted data downloaded from the semiconductor memory device 4, using the shared public key.

As a result, interception through wireless LAN communication can be prevented to enhance the security.

### Fourth Embodiment

A description will be given of a fourth embodiment in which the first to third embodiments are modified in a certain way. In the fourth embodiment, the initial setting data 11 includes access right data.

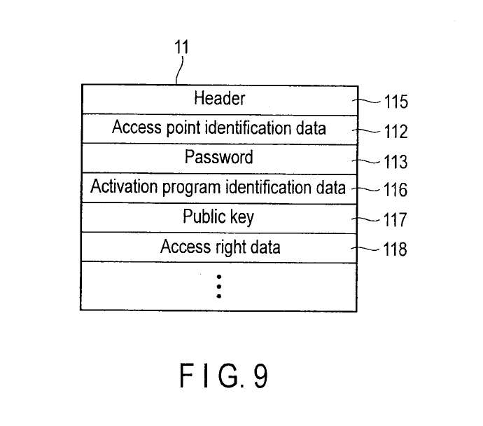

FIG. 9 shows a data structure diagram showing an example of the initial setting data 11 according to the fourth embodiment.

In the fourth embodiment, the initial setting data 11 includes the header 115, the access point identification data 112, the password 113, the activation program identification data 116, the public key 117 and access right data 118.

The access right data 118 is used to determine whether a right of accessing data is provided. The access right data 118 include, for example, user identification data

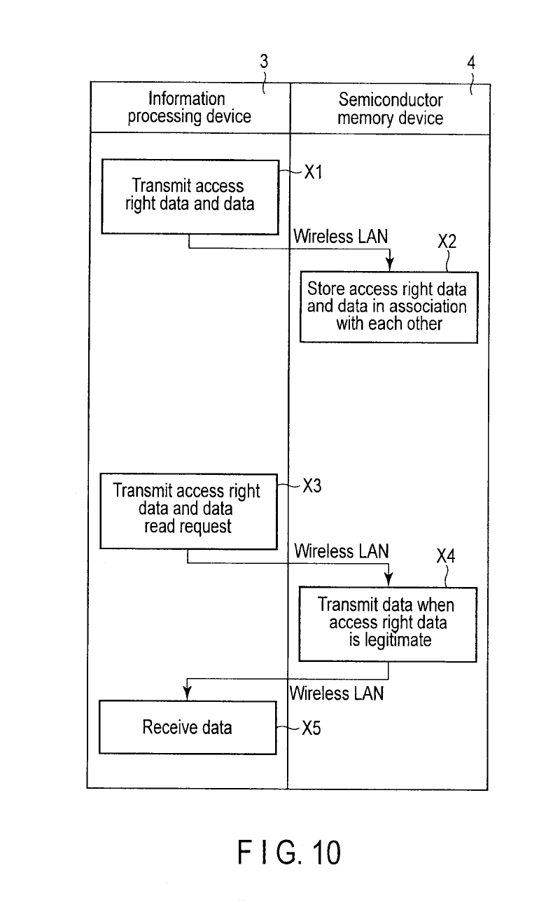

FIG. 10 is a flowchart showing an example of data access from the information processing device 3 to the semiconductor memory device 4 by the information according to the fourth embodiment.

In step X1, the processor 12 of the information processing device 3 transmits, using wireless LAN, the access right data 118 and data to the semiconductor memory device 4 via the wireless communication unit 14 controlled by the wireless communication program 122.

In step X2, the wireless communication unit 8 of the semiconductor memory device 4 receives the access right data 118 and the data, and the controller 7 stores the access right data 118 and the data in association with each other in the nonvolatile semiconductor memory 6.

In step X3, using wireless LAN communication, the processor 12 of the information processing device 3 transmits the access right data 118 and a data read request to the semiconductor memory device 4 via the wireless communication unit 14 controlled by the wireless communication program 122.

In step X4, the wireless communication unit 8 of the semiconductor memory device 4 receives the access right data 118 and the data read request, and the controller 7 reads, from the nonvolatile semiconductor memory 6, the data designated by the data read request when the access right data 118 is legitimate. The controller 7 transmits the read data to the information processing device 3 via the wireless communication unit 8, using wireless LAN communication.

In step X5, the processor 12 of the information processing device 3 receives the data via the wireless communication unit 14 controlled by the wireless communication program 122, using wireless LAN communication.

In the above-described fourth embodiment, only the user having an access right can use the data stored in the semiconductor memory device 4.

Instead of the access right data 118 according to the third embodiment, the initial setting data 11 may include a password that permits a use of data. In this case, the information processing device 3 transmits the data protected by the password to the semiconductor memory device 4 using wireless LAN communication. Further, the information processing device 3 receives the data protected by the password from the semiconductor memory device 4, and releases a protection of the data using the password.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a semiconductor memory device capable of wireless communication;
a near field communication (NFC) antenna configured to generate power based on electromagnetic induction; and
an NFC controller electrically connected to the NFC antenna, configured to store initial setting data associated with wireless communication, and output the initial setting data using the NFC antenna.

2. The memory device of claim 1, wherein wireless communication is wireless local area network (LAN) communication.

3. The memory device of claim 2, wherein the initial setting data includes a wireless LAN activation trigger, access point identification data, a password and access destination designating data.

4. The memory device of claim 2, wherein the initial setting data includes a wireless LAN activation trigger, access point identification data, and a password,
the NFC controller outputs the initial setting data using the NFC antenna to a setting performing device,
the setting performing device turns on wireless LAN communication in response to the wireless LAN activation trigger, executes a connection to an access point based on the access point identification data, and outputs the password to the memory device by wireless LAN communication,
the memory device receives the password by wireless LAN communication, performs an authentication based on the password, and outputs an authentication result to the setting performing device by wireless LAN communication, and
the setting performing device receives the authentication result by wireless LAN communication, and completes wireless LAN communication connection processing if the authentication result is legitimate.

5. The memory device of claim 1, wherein
the NFC antenna includes a loop pattern; and
the NFC controller is provided within an inside diameter space of the loop pattern.

6. A setting device comprising:
a near field communication (NFC) antenna configured to generate power based on electromagnetic induction; and
an NFC controller electrically connected to the NFC antenna, configured to store initial setting data associated with wireless communication, and output the initial setting data using the NFC antenna.

7. The setting device of claim 6, wherein the setting device is a label attached to a semiconductor memory device capable of wireless communication.

8. The setting device of claim 6, wherein the setting device is a seal attached to an inside of a case of a semiconductor memory device capable of wireless communication.

9. The setting device of claim 6, wherein the initial setting data includes a wireless LAN activation trigger, access point identification data, a password and access destination designating data.

10. The setting device of claim 6, wherein the initial setting data includes a wireless LAN activation trigger, access point identification data, and a password,
the NFC controller outputs the initial setting data using the NFC antenna to a setting performing device,
the setting performing device turns on wireless LAN communication in response to the wireless LAN activation trigger, executes a connection to an access point based on the access point identification data, and outputs the password to a memory device capable by wireless LAN communication,
the memory device receives the password by wireless LAN communication, performs an authentication based on the password, and outputs an authentication result to the setting performing device by wireless LAN communication, and
the setting performing device receives the authentication result by wireless LAN communication, and completes wireless LAN communication connection processing if the authentication result is legitimate.

11. The setting device of claim 6, wherein
the NFC antenna includes a loop pattern; and
the NFC controller is provided within an inside diameter space of the loop pattern.

12. A nonvolatile memory medium storing a program which causes a processor to serve as:
a receiving unit configured to receive initial setting data associated with wireless communication of a semiconductor memory device, using near field communication (NFC);
a connection unit configured to execute a wireless communication connection for wireless communication based on the received initial setting data; and
an activation unit configured to activate a program indicated by program identification data included in the initial setting data, after completing of the wireless communication connection.

13. The nonvolatile memory medium of claim 12, wherein the program further causes the processor to serve as:
a generating unit configured to generate the initial setting data; and
an outputting unit configured to output the initial setting data using NFC.

14. The nonvolatile memory medium of claim 12, wherein wireless communication is wireless local area network (LAN) communication.

15. The nonvolatile memory medium of claim 12, wherein the initial setting data includes access point identification data, a password and the program identification data.

16. The nonvolatile memory medium of claim 12, wherein the initial setting data includes access point identification data, a password, the program identification data and key data for encrypting data outputted by wireless communication.

17. The nonvolatile memory medium of claim 12, wherein the initial setting data includes a wireless LAN activation trigger, access point identification data, a password, and the program identification data,
the connection unit turns on wireless LAN communication in response to the wireless LAN activation trigger, executes a connection to an access point based on the access point identification data, and outputs the password to a memory device capable by wireless LAN communication,
the memory device receives the password by wireless LAN communication, performs an authentication based on the password, and outputs an authentication result to the device by wireless LAN communication, and
the connection unit receives the authentication result by wireless LAN communication, and completes wireless LAN communication connection processing if the authentication result is legitimate.
